(19) United States
(12) Patent Application Publication
(10) Pub. No.: US 2026/0173232 A1
(43) Pub. Date: Jun. 18, 2026

(54) LIGHT EMITTING DEVICE

(71) Applicant: SEOUL VIOSYS CO., LTD., Ansan-si (KR)

(72) Inventors: Young Taek AHN, Ansan-si (KR); Seung Ryeol RYU, Ansan-si (KR)

(73) Assignee: SEOUL VIOSYS CO., LTD., Ansan-si (KR)

(21) Appl. No.: 19/414,767

(22) Filed: Dec. 10, 2025

Related U.S. Application Data
(60) Provisional application No. 63/733,680, filed on Dec. 13, 2024.

(51) Int. Cl. H05B 45/14

(52) U.S. Cl. CPC H05B 45/14

(57) ABSTRACT

According to an aspect of the present disclosure, there may be provided a light emitting device including: a plurality of light emitters that generate light; a controller in which calibration information is pre-stored to correct a luminous intensity of the light generated from the plurality of light emitters, and which supplies current to the plurality of light emitters based on the calibration information; and a substrate that supports the controller and the plurality of light emitters, wherein the controller is disposed on the substrate to be spaced apart from the plurality of light emitters.

### TECHNICAL FIELD

The present disclosure relates to a light emitting device.

### BACKGROUND OF INVENTION

Recently, a light emitting diodes (LED) has been widely used. The LED converts an electrical signal into a form of light, such as infrared, visible, or ultraviolet light, using the properties of a compound semiconductor.

As the luminous efficiency of LED is increased, a plurality of LEDs are being applied in various fields, including display devices, lighting equipment, and vehicle lamps.

### CONTENTS OF INVENTION

### Problems to be Solved by Invention

Embodiments of the present disclosure are directed to providing a light emitting device capable of adjusting the luminous intensity of a plurality of light emitting elements.

Further, the embodiments of the present disclosure are intended to provide a lighting device including a plurality of light emitters that generate light having uniform luminous intensity, brightness, and color characteristics.

### Means for Solving Problems

In accordance with an aspect of the present disclosure, there may be provided a light emitting device including: a plurality of light emitters that generate light; a controller in which calibration information is pre-stored to correct a luminous intensity of the light generated from the plurality of light emitters, and which supplies current to the plurality of light emitters based on the calibration information; and a substrate that supports the controller and the plurality of light emitters, wherein the controller is disposed on the substrate to be spaced apart from the plurality of light emitters.

Further, there may be provided the light emitting device in which the controller includes: a memory in which the calibration information is stored; and a device control unit that reads the calibration information stored in the memory to control the plurality of light emitters.

Further, there may be provided the light emitting device in which the controller and the plurality of light emitters are arranged in one direction on the substrate.

Further, there may be provided the light emitting device in which the calibration information includes information on a plurality of current amount supplied to each of the plurality of light emitters.

Further, there may be provided the light emitting device in which the plurality of current amounts included in the calibration information are different.

Further, there may be provided the light emitting device in which the calibration information includes information on a current magnitude supplied to each of the plurality of light emitters.

Further, there may be provided the light emitting device in which the plurality of current magnitudes included in the calibration information are different.

Further, there may be provided the light emitting device in which the calibration information includes information on a current pulse width supplied to each of the plurality of light emitters.

Further, there may be provided the light emitting device in which the plurality of current pulse widths included in the calibration information are different.

Further, there may be provided the light emitting device in which the plurality of light emitters are configured to generate different luminous intensities of light from each other when the same current amount is supplied to the plurality of light emitters.

Further, there may be provided a light emitting device including: a plurality of light emitters that generate light; and a memory in which calibration information for controlling a luminous intensity of the light generated from the plurality of light emitters is stored, wherein the number of memories is less than the number of the plurality of light emitters.

Further, there may be provided the light emitting device further including: a device control unit that reads the calibration information stored in the memory to control the plurality of light emitters, wherein a distance between the device control unit and the memory is shorter than a distance between the memory and any one of the plurality of light emitters.

Further, there may be provided the light emitting device in which the plurality of light emitters are disposed to be spaced apart from each other in one direction, and a distance between the memory and the light emitter closest to the memory among the plurality of light emitters is shorter than a separation distance between adjacent ones of the plurality of light emitters.

Further, there may be provided a light emitting device including: a plurality of first light emitters that generate light; a plurality of second light emitters that generate light of a different peak wavelength from the plurality of first light emitters; a first controller in which first calibration information is pre-stored to correct the luminous intensity of the light generated from the plurality of first light emitters, and which supplies current to the plurality of first light emitters based on the first calibration information; a second controller in which second calibration information is pre-stored to correct the luminous intensity of the light generated from the plurality of second light emitters, and which supplies current to the plurality of second light emitters based on the second calibration information; a first substrate that supports the plurality of first light emitters and the first controller; and a second substrate that supports the plurality of second light emitters and the second controller.

Further, there may be provided the light emitting device in which the plurality of first light emitters are arranged in one direction on the first substrate, the plurality of second light emitters are arranged in the one direction on the second substrate, and the second substrate and the first substrate are disposed to be spaced apart from each other in the one direction.

Further, there may be provided the light emitting device further including: a first communication device supported on the first substrate and communicating with the first controller; and a second communication device supported on the second substrate and communicating with the second controller and the first communication device.

Further, there may be provided the light emitting device in which the first communication device receives information transmitted from an external source and transmits the information to the first controller or to the second communication device.

Further, there may be provided the light emitting device in which a separation distance between the first controller and the second controller is greater than a distance between the first light emitter of the plurality of first light emitters that is closest to the second substrate and the second light emitter of the plurality of second light emitters that is closest to the first substrate.

Further, there may be provided the light emitting device in which the second controller is disposed between the first light emitter of the plurality of first light emitters that is closest to the second substrate and the second light emitter of the plurality of second light emitters that is closest to the first substrate.

Further, there may be provided the light emitting device in which the first controller and the second controller are configured to cause the luminous intensity of the light generated from the plurality of first light emitters and the plurality of second light emitters to be the same.

### Effects of Invention

According to embodiments of the present disclosure, the light intensity, brightness, and color of light emitted from a plurality of light emitters can be made uniform.

In addition, according to the embodiments of the present disclosure, the chromaticity and color reproduction of the plurality of light emitters can be improved by a controller, thereby providing a high quality lighting device.

Furthermore, according to the embodiments of the present disclosure, since a memory may be included in the controller, the size of the lighting device can be reduced, and light having an appropriate light quantity suitable for a desired purpose can be generated.

### BRIEF DESCRIPTION OF DRAWINGS

FIG. 1 is a diagram illustrating a light emitting device according to a first embodiment of the present disclosure.

FIG. 2 is a block diagram of the light emitting device of FIG. 1.

FIG. 3 is a diagram illustrating a state in which a width of a pulse supplied to one of a plurality of light emitters of the light emitting device of FIG. 1 is formed to be smaller than a width of a pulse supplied to another of the plurality of light emitters.

FIG. 4 is a flowchart of a calibration performing method for the light emitting device according to the first embodiment of the present disclosure.

FIG. 5 is a diagram illustrating a light emitting device according to a second embodiment of the present disclosure.

### SPECIFIC CONTENTS FOR EMBODYING INVENTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the DR1-axis, the DR2-axis, and the DR3-axis are not limited to three axes of a rectangular coordinate system, such as the x, y, and z-axes, and may be interpreted in a broader sense. For example, the DR1-axis, the D2R-axis, and the DR3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, a light emitting device 1 according to a first embodiment of the present disclosure will be described.

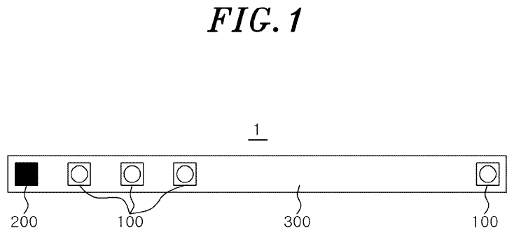

Referring to FIG. 1, the light emitting device 1 according to the first embodiment of the present disclosure may generate light. Furthermore, the light emitting device 1 may be mounted in a vehicle. The light emitting device 1 may be included in a taillight, a headlight, a rear lamp, a tail lamp, ambient lighting, an interior light, and the like. Furthermore, the light emitting device 1 mounted in a vehicle may emit red-based light, yellow-based light, or white-based light to display information such as a stop signal or characters to the outside. The light emitting device 1 may be a high-quality display device that reduces optical interference between a plurality of light emitters 100 and minimizes interference between driving regions to have a distinct contrast ratio and exhibit clear contrast. The light emitting device 1 may include a light emitter 100, a controller 200, and a substrate 300.

A plurality of the light emitters 100 may be formed to generate light. The plurality of light emitters 100 may generate light of at least one peak wavelength. Furthermore, at least two of the plurality of light emitters 100 may have different peak wavelengths from each other. The plurality of light emitters 100 may be spaced apart from each other in one direction and arranged on the substrate 300. The plurality of light emitters 100 may be configured to generate light of different luminous intensities. Hereinafter, one of the plurality of light emitters 100 is designated as a first sub light emitter 100a, and another of the plurality of light emitters 100 is designated as a second sub light emitter 100b. Furthermore, when the same current amount is supplied to the first sub light emitter 100a and the second sub light emitter 100b, the light from the first sub light emitter 100a and the light from the second sub light emitter 100b may have different luminous intensities, luminances, and chromaticities from each other.

Meanwhile, at least one of the plurality of light emitters 100 may include R, G, B sub-pixels. The R, G, B sub-pixels may respectively include a red sub-pixel R, a green sub-pixel G, and a blue sub-pixel B. Furthermore, when all of the R, G, and B sub-pixels of the light emitter 100 operate, the light emitter 100 may generate white light. Furthermore, a calibration may be performed such that the color coordinates of a first light emitter, which generates white light by operating all R, G, B sub-pixels among the plurality of light emitters 100, and the color coordinates of a second light emitter, which generates white light by operating all R, G, B sub-pixels, are formed to be the same value. A difference between the color coordinates of a light emitter that generates calibrated white light and the color coordinates of a light emitter in which all R, G, B sub-pixels are turned off may be ±0.003 or less.

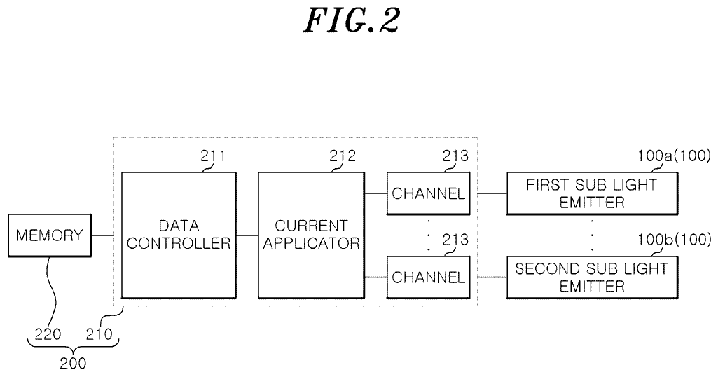

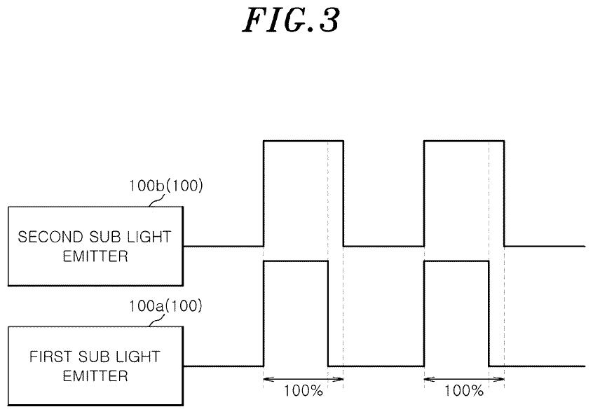

Referring further to FIG. 2 and FIG. 3, the controller 200 may control the plurality of light emitters 100 based on pre-stored calibration information so that at least one of the luminous intensity, luminance, and chromaticity of the light generated from the plurality of light emitters 100 is formed to be identical or similar. In other words, the controller 200 may supply current to each of the plurality of light emitters 100 based on the calibration information to correct the luminous intensity of the plurality of light emitters 100.

The calibration information may include device information regarding the luminous intensity, luminance, color coordinates, and chromaticity of each of the plurality of light emitters 100. Furthermore, the calibration information may include information or logic data regarding the current amount, current magnitude, current pulse width, current supply time, etc., that should be supplied to each of the plurality of light emitters 100.

For example, a plurality of current amounts included in the calibration information may be different from each other. Furthermore, a plurality of current magnitudes included in the calibration information may be different from each other. Furthermore, a plurality of current pulse widths included in the calibration information may be different from each other. Furthermore, a plurality of current supply times included in the calibration information may be different from each other.

A plurality of pieces of calibration information may be formed to correspond to each of the plurality of light emitters 100. At least some of the plurality of pieces of calibration information may be formed to be different from each other. For example, a current amount included in one of the plurality of pieces of calibration information may be different from a current amount included in another of the plurality of pieces of calibration information. Furthermore, a plurality of current magnitudes included in one of the plurality of pieces of calibration information may be different from a current magnitude included in another of the plurality of pieces of calibration information. Furthermore, a current pulse width included in one of the plurality of pieces of calibration information may be different from a current pulse width included in another of the plurality of pieces of calibration information. Furthermore, a current supply time included in one of the plurality of pieces of calibration information may be different from a current supply time included in another of the plurality of pieces of calibration information.

Based on this calibration information, the controller 200 may cause the current amount supplied to the first sub light emitter 100a to be less than the current amount supplied to the second sub light emitter 100b. Furthermore, the controller 200 may form the magnitude of the current supplied to the first sub light emitter 100a to be smaller than the magnitude of the current supplied to the second sub light emitter 100b. Furthermore, the controller 200 may form the supply time of the current supplied to the first sub light emitter 100a to be shorter than the supply time of the current supplied to the second sub light emitter 100b. The controller 200 may form the width of the current pulse supplied to the first sub light emitter 100a to be smaller than the width of the current pulse supplied to the second sub light emitter 100b. Furthermore, the controller 200 may include a device control unit 210 and a memory 220.

The device control unit 210 may control at least one of a current amount, a current magnitude, a current supply time, and a current pulse width supplied to each of the plurality of light emitters 100 based on at least one of information stored in the memory 220 and the calibration information. By means of this device control unit 210, the luminous intensity, luminance, color coordinates, and chromaticity of the light from the plurality of light emitters 100 may be formed to be identical or similar. Furthermore, the number of device control units 210 may be less than the number of light emitters 100. The device control unit 210 may include a data controller 211, a current applicator 212, and a plurality of channels 213.

The data controller 211 may scan the information in the memory 220 so that the plurality of light emitters 100 are controlled simultaneously. In other words, the data controller 211 may read information corresponding to the plurality of light emitters 100 in the memory 220, distribute the information according to the number of the plurality of channels 213, and transmit the information to the current applicator 212. For example, the data controller 211 may distribute at least one of calibration information and a correction value, to be described later, for each of the plurality of channels 213 and transmit it to the current applicator 212.

The current applicator 212 may control the current supplied to the plurality of light emitters 100. Furthermore, the current applicator 212 may supply current to the plurality of channels 213. In other words, the current applicator 212 may control the current supplied to the plurality of channels 213 based on the information applied from the data controller 211. For example, the current applicator 212 may control the current supplied to the plurality of channels 213 based on at least one of a plurality of pieces of calibration information and correction values.

Each of the plurality of channels 213 may be connected to a respective one of the plurality of light emitters 100 to supply current to the plurality of light emitters 100. In other words, one of the plurality of channels 213 may be connected to the first sub light emitter 100a, and another of the plurality of channels 213 may be connected to the second sub light emitter 100b. By means of this plurality of channels 213, the plurality of light emitters 100 may be supplied with the current controlled by the current applicator 212.

The memory 220 may store the calibration information. The number of memories 220 may be formed to be less than the number of the plurality of light emitters 100. The memory 220 may be disposed separately from the light emitter 100. A separation distance between the memory 220 and the device control unit 210 may be smaller than a separation distance between the plurality of light emitters 100. Since the memory 220 and the device control unit 210 are spaced apart, an influence of heat from the memory 220 on the light emitter 100 may be reduced, and reliability may be increased. Furthermore, the separation distance between the memory 220 and the device control unit 210 may be shorter than a separation distance between one of the plurality of light emitters 100 that is disposed most adjacent to the controller 200. Through this, an influence of heat from the controller 200 on the light emitter 100 may be reduced, and reliability may be increased. Furthermore, a separation distance between the memory 220 and the light emitter 100 among the plurality of light emitters 100 that is disposed most adjacent to the controller 200 may be shorter than the separation distance between the plurality of light emitters 100, and thus an occurrence of signal interference on the substrate 300 may be reduced. Furthermore, the memory 220 may store the color coordinates value of each of the plurality of light emitters 100. Furthermore, the memory 220 may include a correction value for correcting the color coordinates or luminance of each of the plurality of light emitters 100. Furthermore, the memory may store the color coordinates or luminance values of the R, G, B sub-pixels of each of the plurality of light emitters 100. Furthermore, the memory 220 may include a correction value for correcting the R, G, B values of the sub-pixels of each of the plurality of light emitters 100. Through this, design difficulty may be reduced.

The substrate 300 may be formed to be elongated in one direction and may support the plurality of light emitters 100 and the controller 200. The substrate 300 may have a wiring part made of a metal or a metal compound such as Cu, Al, Ag, Au, Ni, or W added on top of an insulating layer composed of alumina, quartz, calcium zirconate, forsterite, SiC, graphite, fused silica, mullite, cordierite, zirconia, beryllia, and aluminum nitride, low temperature co-fired ceramic (LTCC), a substrate combining glass or paper with Paper phenolic or Epoxy resin, or P.I (Polyimide), B.T (Bismaleimide/Triazine), Teflon, PMMA, PC (Polycarbonate), or the like. The substrate 300 may be a Printed Circuit Board (PCB) including metal wiring. Furthermore, light-transmissive materials such as glass, quartz, PET film, PI, and polyamide may be used. Furthermore, the substrate 300 may have restoring force or flexibility. Furthermore, the substrate 300 may be formed to be elongated in one direction.

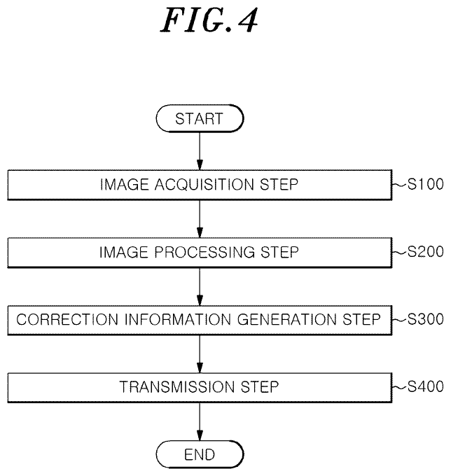

Hereinafter, a calibration performing method for calibrating the plurality of light emitters 100 of the light emitting device according to the first embodiment will be described with reference to FIG. 4.

The calibration performing method may include an image acquisition step S100, an image processing step S200, a correction information generation step S300, and a transmission step S400.

The image acquisition step S100 is a step of capturing a light emission image of the plurality of light emitters 100 to measure at least one value of the luminance and color coordinates of each of the plurality of light emitters 100. In the image acquisition step S100, a camera or a sensor may be used to measure at least one value of the luminance and color coordinates.

The image processing step S200 is a step of analyzing at least one value of the luminance and color coordinates of each of the plurality of light emitters 100 measured in the image acquisition step S100. In other words, in the image processing step S200, an average, a deviation, or an imbalance of at least one value of the luminance and color coordinates of each of the plurality of light emitters 100 may be measured.

The correction information generation step S300 is a step of generating calibration information or a correction value for making the luminance, color coordinates, and luminous intensity of the plurality of light emitters 100 identical or similar based on the average, deviation, or imbalance of at least one value of the luminance and color coordinates of each of the plurality of light emitters 100 measured in the image processing step S200.

As a first example, a reference point for the correction value may be the luminance of the light emitter 100 having the lowest luminance among the plurality of light emitters 100. A correction value may be set such that the luminance of the plurality of light emitters 100 is set to a luminance of a light emitter 100 having the lowest luminance among the plurality of light emitters 100. In other words, a light emitter 100 having a high luminance may have a correction value for reducing the luminance. Through this, design difficulty may be reduced while ensuring long-term reliability.

As a second example, the reference point for the correction value may be set to the average luminance of the light emitters 100. For each of the plurality of light emitters 100, a correction value may be set such that its luminance becomes a luminance similar to the average luminance. A difference between the similar luminance and the average luminance may be within ±10%. A light emitter 100 having a high luminance may have a correction value for reducing the luminance so that it is set to a luminance similar to the average luminance. Furthermore, a light emitter 100 having a low luminance may have a correction value for increasing the luminance so that it is set to a luminance similar to the average luminance. Through this, design difficulty may be reduced while maintaining luminance uniformity.

As a third example, the reference point for the correction value may be set based on a color temperature similar to the average color temperature of the plurality of light emitters 100. For each of the plurality of light emitters 100, a correction value may be set such that its color temperature is set to a color temperature similar to the average color temperature. For example, if the average color temperature of the plurality of light emitters is 6500K, each of the plurality of light emitters 100 may have a correction value for forming its average color coordinates to be a value close to (0.31, 0.32) based on (x, y) color coordinates. So that the color temperatures among the plurality of light emitters 100 are similar, the color coordinate deviation may be within ±0.009. More preferably, the correction value may be set such that the color coordinates of the plurality of light emitters 100 have a deviation within ±0.003.

For more detailed color temperature coordinate adjustment, the R, G, B sub-pixels may each have a different correction value. For example, a light emitter 100 having a low color temperature may have a correction value that increases the luminance of a B sub-pixel among the sub-pixels. Alternatively, a light emitter 100 having a low color temperature may have a correction value that reduces the luminance of an R sub-pixel among the sub-pixels. As another example, a light emitter 100 having a high color temperature may have a correction value that reduces the luminance of a B sub-pixel among the sub-pixels. Alternatively, a light emitter 100 having a high color temperature may have a correction value that increases the luminance of an R sub-pixel among the sub-pixels. Through this, color uniformity may be increased.

The transmission step S400 is a step of transmitting the calibration information or the correction value to the controller 200. In other words, in the transmission step S400, the calibration information or the correction value may be stored in the memory 220.

Hereinafter, the operation and effects of the light emitting device 1 according to the first embodiment of present disclosure will be described.

The controller 200 of the light emitting device 1 according to the embodiment of present disclosure may control a current based on the calibration information and supply it to each of the plurality of light emitters 100. In other words, the controller 200 may form a current amount supplied to one of the plurality of light emitters 100 to be smaller than a current amount supplied to another of the plurality of light emitters 100.

By means of this controller 200, the light from the plurality of light emitters 100 may have identical or similar luminous intensity, luminance, and chromaticity.

Furthermore, since the chromaticity and color reproduction rate of the plurality of light emitters 100 may be enhanced, a high-quality light emitting device 1 may be provided.

Furthermore, since the memory 220 may be included in the controller 200, the size of the light emitting device 1 may be made smaller, and an appropriate amount of light that meets the intended purpose may be generated.

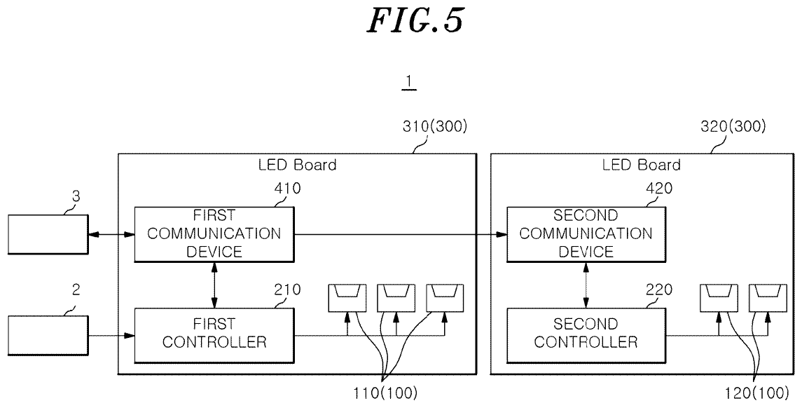

Hereinafter, a light emitting device 1 according to a second embodiment of the present disclosure will be described with reference to FIG. 5.

In describing the second embodiment, the description will focus on the differences, which are that a communication device 400 is further included, that a plurality of controllers 200 and substrates 300 are formed, and that the plurality of light emitters 100 include a plurality of first light emitters 110 and a plurality of second light emitters 120.

The plurality of first light emitters 110 may be disposed on a first substrate 310 to be described later. The plurality of first light emitters 110 may generate light of the same peak wavelength as each other. The number of the plurality of first light emitters 110 and the number of the plurality of second light emitters 120 may be formed to be the same or different. For example, the number of the plurality of first light emitters 110 may be greater than the number of the plurality of second light emitters 120.

The plurality of second light emitters 120 may be disposed on a second substrate 320 to be described later. The plurality of second light emitters 120 may generate light of the same peak wavelength as each other. Furthermore, the plurality of second light emitters 120 may generate light of a different peak wavelength from the plurality of first light emitters 110 or may generate light of the same peak wavelength.

The plurality of controllers 200 may supply a current supplied from the outside to the plurality of light emitters 100. For example, the plurality of controllers 200 may be supplied with current from a power supply device 2. For example, the power supply device 2 may be a vehicle battery disposed in a vehicle. The plurality of controllers 200 may include a first controller 200a and a second controller 200b.

The first controller 200a may correct the luminous intensity of the light of the plurality of first light emitters 110. The first controller 200a may supply current to the plurality of first light emitters 110 based on pre-stored first calibration information. The first calibration information may include information regarding the luminous intensity, luminance, color coordinates, and chromaticity of each of the plurality of first light emitters 110. Furthermore, the first calibration information may include at least one of a current amount, a current supply time, a current pulse width, and a current magnitude supplied to each of the plurality of first light emitters 110. By means of this first controller 200a, the light generated from the plurality of first light emitters 110 may have the same luminous intensity, luminance, and color coordinates as each other. The light generated from the plurality of first light emitters 110 and the light generated from the plurality of second light emitters 120 may have different luminous intensities, luminances, and color coordinates from each other. Furthermore, the light generated from the plurality of first light emitters 110 and the light generated from the plurality of second light emitters 120 may have identical or similar luminous intensities, luminances, and color coordinates.

The second controller 200b may correct the luminous intensity of the light of the plurality of second light emitters 120. The second controller 200b may supply current to the plurality of second light emitters 120 based on pre-stored second calibration information. The second calibration information may include information regarding the luminous intensity, luminance, and chromaticity of each of the plurality of second light emitters 120. Furthermore, the second calibration information may include at least one of a current amount, a current supply time, a current pulse width, and a current magnitude supplied to each of the plurality of second light emitters 120. By means of this second controller 200b, the light generated from the plurality of second light emitters 120 may have the same luminous intensity, luminance, and chromaticity as each other.

Furthermore, the second controller 200b may be disposed between a first light emitter 110 of the plurality of first light emitters 110 that is disposed most adjacent to the second substrate 320, and a second light emitter 120 of the plurality of second light emitters 120 that is disposed most adjacent to the first substrate 310.

A separation distance between the first controller 200a and the second controller 200b may be formed to be greater than a distance between a first light emitter 110 of the plurality of first light emitters 110 disposed closest to a second substrate 320, to be described later, and a second light emitter 120 of the plurality of second light emitters 120 disposed closest to the first substrate 310.

The plurality of substrates 300 may be spaced apart from each other in one direction and may support the plurality of light emitters 100, the plurality of controllers 200, and a plurality of communication devices 400. The plurality of substrates 300 may include a first substrate 310 and a second substrate 320.

The first substrate 310 may support the plurality of first light emitters 110, the first controller 200a, and a first communication device 410 to be described later. The second substrate 320 may support the plurality of second light emitters 120, the second controller 200b, and a second communication device 420 to be described later. The first substrate 310 and the second substrate 320 may be disposed to be spaced apart from each other in one direction.

The communication device 400 may be configured to communicate with the controller 200 and an external communication device 3 disposed externally. The communication device 400 may transmit information transmitted from the plurality of controllers 200 to the external communication device 3 or transmit information transmitted from the external communication device 3 to the controller 200. For example, the communication device 400 may be controlled by the controller 200a to transmit information about the light generated from the plurality of light emitters 100 to the external communication device 3. Furthermore, based on information transmitted from the external communication device 3, the controller 200 may control the plurality of light emitters 100. For example, the information transmitted from the external communication device 3 may be control information for driving the plurality of light emitters 100. Furthermore, the communication device 400 may include a first communication device 410 and a second communication device 420.

The first communication device 410 is disposed on the first substrate 310 and may communicate with the first controller 200a, the second communication device 420, and the external communication device 3. The first communication device 410 may transmit information to be transmitted from the outside to the first controller 200a and the second communication device 420. Furthermore, the first communication device 410 may transmit information transmitted from the first controller 200a and the second communication device 420 to the external communication device 3.

The second communication device 420 is disposed on the second substrate 320 and may communicate with the second controller 200b and the first communication device 410. The second communication device 420 may transmit information to be transmitted from the first communication device 410 to the second communication device 420. Furthermore, the second communication device 420 may transmit information transmitted from the second controller 200b to the first communication device 410.

Meanwhile, although the communication device 400 has been described as being external to the controller 200, the invention is not limited thereto, and the communication device 400 may be included in the controller 200. In other words, the first communication device 410 may be included in the first controller 200a. Furthermore, the second communication device 420 may be included in the second controller 200b.

Hereinafter, the operation and effects of the light emitting device 1 according to the second embodiment will be described.

The first controller 200a and the second controller 200b may control the current supplied from the power supply device 2 and supply it to the plurality of first light emitters 110 and the plurality of second light emitters 120. By means of this first controller 200a and second controller 200b, the plurality of first light emitters 110 and the plurality of second light emitters 120 may generate light simultaneously or sequentially.

Furthermore, since the first controller 200a may supply the current from the power supply device 2 to the plurality of first light emitters 110 based on the first calibration information, the light from the plurality of first light emitters 110 may have the same luminous intensity, chromaticity, and luminance as each other.

Furthermore, since the second controller 200b may supply the current from the power supply device 2 to the plurality of second light emitters 120 based on the second calibration information, the light from the plurality of second light emitters 120 may have the same luminous intensity, chromaticity, and luminance as each other.

Furthermore, since the plurality of first light emitters 110 and the plurality of second light emitters 120 may be arranged in one direction and simultaneously generate light to have the same luminous intensity, chromaticity, and luminance, a high-quality light emitting device 1 may be provided.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

### DESCRIPTION OF REFERENCE NUMERALS

1: lighting emitting device
2: power supply device
3: external communication device
100: light emitter
100a: first sub light emitter
100b: second sub light emitter
110: first light emitter
120: second light emitter
200: controller
210: device control unit
220: memory
200a: first controller
200b: second controller
300: substrate
310: first substrate
320: second substrate
400: communication device
410: first communication device
420: second communication device

1. A light emitting device comprising:
a plurality of light emitters that generate light;
a controller in which calibration information is pre-stored to correct a luminous intensity of the light generated from the plurality of light emitters, and which supplies current to the plurality of light emitters based on the calibration information; and
a substrate that supports the controller and the plurality of light emitters,
wherein the controller is disposed on the substrate to be spaced apart from the plurality of light emitters.

2. The light emitting device of claim 1, wherein the controller comprises:
a memory in which the calibration information is stored; and
a device control unit that reads the calibration information stored in the memory to control the plurality of light emitters.

3. The light emitting device of claim 1, wherein the controller and the plurality of light emitters are arranged in one direction on the substrate.

4. The light emitting device of claim 1, wherein the calibration information includes information on a plurality of current amount supplied to each of the plurality of light emitters.

5. The light emitting device of claim 4, wherein the plurality of current amounts included in the calibration information are different.

6. The light emitting device of claim 1, wherein the calibration information includes information on a current magnitude supplied to each of the plurality of light emitters.

7. The light emitting device of claim 6, wherein the plurality of current magnitudes included in the calibration information are different.

8. The light emitting device of claim 1, wherein the calibration information includes information on a current pulse width supplied to each of the plurality of light emitters.

9. The light emitting device of claim 8, wherein the plurality of current pulse widths included in the calibration information are different.

10. The light emitting device of claim 1, wherein the plurality of light emitters are configured to generate different luminous intensities of light from each other when the same current amount is supplied to the plurality of light emitters.

11. A light emitting device comprising:
a plurality of light emitters that generate light; and
a memory in which calibration information for controlling a luminous intensity of the light generated from the plurality of light emitters is stored,
wherein the number of memories is less than the number of the plurality of light emitters.

12. The light emitting device of claim 11, further comprising:
a device control unit that reads the calibration information stored in the memory to control the plurality of light emitters,
wherein a distance between the device control unit and the memory is shorter than a distance between the memory and any one of the plurality of light emitters.

13. The light emitting device of claim 11, wherein the plurality of light emitters are disposed to be spaced apart from each other in one direction, and
a distance between the memory and the light emitter closest to the memory among the plurality of light emitters is shorter than a separation distance between adjacent ones of the plurality of light emitters.

14. A light emitting device comprising:
a plurality of first light emitters that generate light;
a plurality of second light emitters that generate light of a different peak wavelength from the plurality of first light emitters;
a first controller in which first calibration information is pre-stored to correct the luminous intensity of the light generated from the plurality of first light emitters, and which supplies current to the plurality of first light emitters based on the first calibration information;
a second controller in which second calibration information is pre-stored to correct the luminous intensity of the light generated from the plurality of second light emitters, and which supplies current to the plurality of second light emitters based on the second calibration information;
a first substrate that supports the plurality of first light emitters and the first controller; and
a second substrate that supports the plurality of second light emitters and the second controller.

15. The light emitting device of claim 14, wherein the plurality of first light emitters are arranged in one direction on the first substrate, the plurality of second light emitters are arranged in the one direction on the second substrate, and the second substrate and the first substrate are disposed to be spaced apart from each other in the one direction.

16. The light emitting device of claim 14, further comprising:
a first communication device supported on the first substrate and communicating with the first controller; and
a second communication device supported on the second substrate and communicating with the second controller and the first communication device.

17. The light emitting device of claim 16, wherein the first communication device receives information transmitted from an external source and transmits the information to the first controller or to the second communication device.

18. The light emitting device of claim 14, wherein a separation distance between the first controller and the second controller is greater than a distance between the first light emitter of the plurality of first light emitters that is closest to the second substrate and the second light emitter of the plurality of second light emitters that is closest to the first substrate.

19. The light emitting device of claim 14, wherein the second controller is disposed between the first light emitter of the plurality of first light emitters that is closest to the second substrate and the second light emitter of the plurality of second light emitters that is closest to the first substrate.

20. The light emitting device of claim 14, wherein the first controller and the second controller are configured to cause the luminous intensity of the light generated from the plurality of first light emitters and the plurality of second light emitters to be the same.
